(19) United States
(12) Patent Application Publication
(10) Pub. No.: US 2026/0299759 A1
(43) Pub. Date: Oct. 1, 2026

(54) MANAGING AN APP, SUCH AS AN APP FOR A SHOPFLOOR COMPUTER AND FIELD DEVICE INTERPLAY, METHOD AND SYSTEM

(71) Applicant: Siemens Industry Software SAS, Châtillon (FR)

(72) Inventor: Stephane Vanhoecke, Toulouse (FR)

(21) Appl. No.: 19/096,189

(22) Filed: Mar. 31, 2025

(51) Int. Cl. G06F 3/0484; G06F 9/451

(52) U.S. Cl. CPC G06F 3/0484; G06F 9/451

(57) ABSTRACT

For improved management of an app for a shopfloor computer and field device interplay, a method includes providing an app management user interface of an app management platform to a user for managing an app including an app model, a plurality of app entities, and a plurality of app workflows. First user input indicative of a shopfloor computer and of a respective field device arranged in a shopfloor of a production facility is received. Execution of the app on the app management platform is triggered. Execution of at least one shopfloor app workflow included in the plurality of app workflows is triggered in a web browser executed on the shopfloor computer. Provision of a protocol converter executed is triggered on the shopfloor computer. The protocol converter converts a first data format used by the app into a second data format used by the respective field device and vice versa.

### TECHNICAL FIELD

The present disclosure is directed, in general, to software management systems, in particular systems for managing apps, that may be used to manage, build, test, deploy and iterate such apps (collectively referred to here-in as product systems).

### BACKGROUND

The present embodiments generally relate to the management of an app, such as an app for a shopfloor computer and field device interplay, method, and system.

Recently, an increasing number of computer software products are used both for personal needs and for business needs in the form of applications (throughout the present patent document, referred to as “apps”). Such apps may be used in a mobile context as well as on cloud computing platforms and “on premise,” and may provide a specific set of functions.

Currently, there exist product systems and solutions that support managing such apps. Such product systems may benefit from improvements.

### SUMMARY AND DESCRIPTION

Variously disclosed embodiments include methods and computer systems that may be used to facilitate managing an app, such as an app for a shopfloor computer and field device interplay.

According to a first aspect of the present embodiments, a computer-implemented method may include: providing an app management user interface (UI) of an app management platform to a user for managing an app including an app model, a plurality of app entities, and a plurality of app workflows; receiving first user input indicative of a shopfloor computer and of a respective field device arranged in a shopfloor of a production facility, respectively, wherein some of the app entities relate to sensor data or to control data associated with one or more field devices, and wherein some of the app entities are associated with respective app workflow; triggering execution of the app on the app management platform; triggering execution of at least one shopfloor app workflow included in the plurality of app workflows in a web browser executed on the shopfloor computer; and triggering provision of a protocol converter executed on the shopfloor computer, wherein the protocol converter is configured to convert a first data format used by the app into a second data format used by the respective field device and vice versa.

According to a second aspect of the present embodiments, another computer-implemented method may include: receiving a message from an app management platform wherein the app management platform is configured to execute an app including an app model, a plurality of app entities, and a plurality of app workflows, wherein the message indicates a respective field device arranged in a shopfloor of a production facility, wherein the message further includes an instruction to execute at least one shopfloor app workflow included in the plurality of app workflows in a web browser, wherein the message further includes an instruction to provide a protocol converter, wherein the protocol converter is configured to convert a first data format used by the app into a second data format used by the respective field device and vice versa, wherein some of the app entities relate to sensor data or to control data associated with one or more field devices, and wherein some of the app entities are associated with respective app workflow; executing the respective shopfloor app workflow in the web browser; and providing and executing the protocol converter.

According to a third aspect of the present embodiments, a computer system may be arranged and configured to execute the steps of one of these computer-implemented methods according to the first or second aspect.

According to a fourth aspect, a computer program product may include computer program code that, when executed by the computer system according to the third aspect, causes the computer system to carry out the method according to the first or the second aspect.

According to a fifth aspect, a computer-readable medium may include the computer program product according to the fourth aspect. By way of example, the described computer-readable medium may be non-transitory and may further be a software component on a storage device.

The foregoing has outlined rather broadly the technical features of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiments disclosed as a basis for modifying or designing other structures for carrying out the same purposes of the present disclosure. Those skilled in the art will also realize that such equivalent constructions do not depart from the spirit and scope of the disclosure in its broadest form.

Also, before undertaking the detailed description below, it should be understood that various definitions for certain words and phrases are provided throughout this patent document and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

Embodiments will be described below in greater detail.

### BRIEF DESCRIPTION OF THE DRAWINGS

FIGS. 1-7 depict a functional block diagram of example systems that facilitate managing an app, such as an app for a shopfloor computer and field device interplay, in a product system, respectively.

FIG. 8 depicts an example schematic overview of an app and an app model in the context of facilitating managing an app, such as an app for a shopfloor computer and field device interplay, in a product system.

FIGS. 9-14 depict various aspects of example app development user interfaces that facilitate managing an app, such as an app for a shopfloor computer and field device interplay, in a product system, respectively.

FIGS. 15-20 depict a flow diagram of an example methodology that facilitates managing an app, such as an app for a shopfloor computer and field device interplay, in a product system, respectively.

FIG. 21 depicts a block diagram of a data processing system in which an embodiment may be implemented.

### DETAILED DESCRIPTION

Various technologies that pertain to systems and methods for managing an app, such as an app for a shopfloor computer and field device interplay, in a product system will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present patent document will be described with reference to example non-limiting embodiments.

An app generally refers to a software program that on execution performs specific desired tasks. In general, several apps are executed in a runtime environment containing one or more operating systems (“OSs”), virtual machines (e.g., supporting Java™ programming language), device drivers, etc.

Apps, including native apps, may be created, edited, and represented using traditional source code. Examples of such traditional source code include C, C++, Java, Flash, Python, Perl, and other script-based methods of representing an app. Developing, creating and managing such script-based apps, or parts of such script-based apps may be accomplished by manual coding of suitably trained users.

Developers often use Application Development Frameworks (“ADFs”) (that are by themselves applications or apps) for implementing/developing desired apps. An ADF provides a set of pre-defined code/data modules that may be directly/indirectly used in the development of an app. An ADF may also provide tools such as an Integrated Development Environment (“IDE”), code generators, debuggers, etc. that facilitate a developer in coding/implementing the desired logic of the app in a faster/simpler manner.

In general, an ADF simplifies app development by providing reusable components that may be used by app developers to define user interfaces (“UIs”) and app logic by, for example, selecting components to perform desired tasks and defining the appearance, behavior, and interactions of the selected components. Some ADFs are based on a model-view-controller design pattern that promotes loose coupling and easier app development and maintenance.

According to another approach, apps may also be created, edited, and represented using visual model-based representations. Unlike traditional source code implementations, such apps may be created, edited, and/or represented by drawing, moving, connecting, and/or disconnecting visual depictions of logical elements within a visual modeling environment. Visual model-based representations of apps may use symbols, shapes, lines, colors, shades, animations, and/or other visual elements to represent logic, data or memory structures or user interface elements. In order to program a traditional script-based app, programmers are typically required to type out detailed scripts according to a complicated set of programming syntax rules. In contrast, programming a visual model-based app may, in some cases, be done by connecting various logical elements (e.g., action blocks and/or decision blocks) to create a visual flow chart that defines the app's operation. Similarly, defining data structures (e.g., variable types, database objects, or classes) and/or user interface elements (e.g., dropdown boxes, lists, text input boxes) in a visual model-based app may be done by drawing, placing, or connecting visual depictions of logical elements within a virtual workspace, as opposed to typing out detailed commands in a script. Visual-model based apps, including native apps, may therefore be more intuitive to program and/or edit compared to traditional script-based apps. In the present document, an approach is suggested to manage apps, such as to create an app including to develop a user interface of the app, which may involve the explained visual model-based representations.

For brevity, references to a “model,” a “visual model,” or an “application” or “app” should be understood to refer to visual model-based apps, including native apps, unless specifically indicated. In some cases, such visual model-based apps may represent complete, stand-alone apps for execution on a computer system. Visual model-based apps may also represent discrete modules that are configured to perform certain tasks or functions, but do not represent complete apps; instead, such discrete modules may be inserted into a larger app or combined with other discrete modules to perform more complicated tasks. Examples of such discrete modules may include modules for validating a ZIP code, for receiving information regarding current weather from a weather feed, and/or for rendering graphics.

Visual models may be represented in two forms: an internal representation and one or more associated visual representations. The internal representation may be a file encoded according to a file format used by a modeling environment to capture and define the operation of an app (or part of an app). For example, the internal representation may define what inputs an app may receive, what outputs an app may provide, the algorithms and operations by which the app may arrive at results, what data the app may display, what data the app may store, etc. The internal representation may also be used to instruct an execution environment how to execute the logic of the app during run-time. Internal representations may be stored in the form of non-human-readable code (e.g., binary code). Internal representations may also be stored according to a binary stored JSON (java script object notation) format, and/or an XML format. At run-time, an execution engine may use an internal representation to compile and/or generate executable machine code that, when executed by a processor, causes the processor to implement the functionality of the model.

The internal representation may be associated with one or more visual representations. Visual representations may include visual elements that depict how an app's logic flows, but are not designed to be compiled or executed. These visual representations may include, for example, flow-charts or decision trees that show a user how the app will operate. The visual models may also visually depict data that is to be received from the user, data that is to be stored, and data that is to be displayed to the user. These visual models may also be interactive, which allows a user to manipulate the model in an intuitive way. For example, visual representations may be configured to display a certain level of detail (e.g., number of branches, number of displayed parameters, granularity of displayed logic) by default. However, users may interact with the visual representation in order to show a desired level of detail—for example, users may display or hide branches of logic, and/or display or hide sets of parameters. Details relating to an element of the visual model may be hidden from view by default but may appear in a sliding window or pop-up that appears on-screen when the user clicks on the appropriate element. Users may also zoom in or out of the model, and/or pan across different parts of the model, to examine different parts of the model. Users may also copy or paste branches of logic from one section of the model into another section, or copy/paste branches of logic from a first model into a second model. In some cases, parts of the model may contain links to other parts of the model, such that if a user clicks on a link, the user will automatically be led to another part of the model. A viewing user may interact with a visual representation in at least some of the same ways that the viewing user might interact with the model if it were displayed within a modeling environment. In other words, the visual representation may be configured to mimic how the model would appear if it were displayed within a visual modeling environment. A single internal representation may correspond to multiple visual representations that use different styles or formatting rules to display app logic. For instance, multiple visual representations corresponding to the same internal representation may differ from one another in their use of color, elements that are included or omitted, and use of symbols, shapes, lines, colors, and/or shades to depict logic flow.

Approaches involving the above-described functionalities of visual model-based representations, visual model-based apps, and/or visual models are sometimes understood to be included by a so-called low-code application development platform or low-code app development platform. By way of example, such a low-code application development platform may further be described as software that provides a development environment used to create application software through graphical user interfaces and configuration instead of traditional hand-coded computer programming. A low-code model may enable developers of varied experience levels to create applications using a visual user interface in combination with model-driven logic. Such low-code application development platforms may produce entirely operational apps or require additional coding for specific situations. Low-code app development platforms may reduce the amount of traditional hand coding, enabling accelerated delivery of business apps. A common benefit is that a wider range of people may contribute to the app's development—not only those with formal programming skills. Low-code app development platforms may also lower the initial cost of setup, training, deployment, and maintenance.

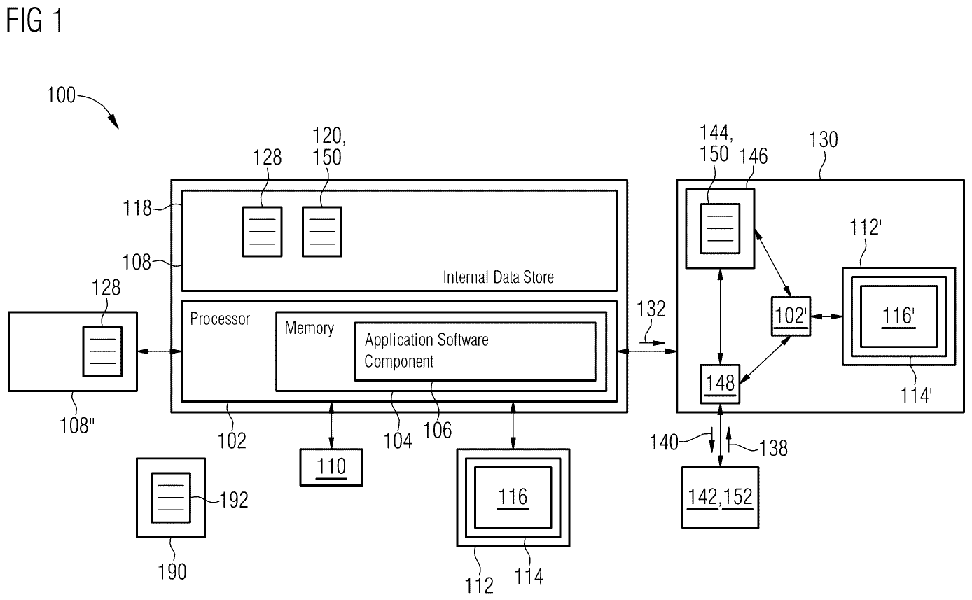

With reference to FIG. 1, a functional block diagram of a first example computer system or data processing system 100 is depicted that facilitates managing an app 120, such as an app 120 for a shopfloor computer 130 and field device 142 interplay, in a product system 100. The processing system 100 may include an app development platform 118 that may, in some examples, include at least one processor 102 that is configured to execute at least one application software component 106 from a memory 104 accessed by the processor 102. The application software component 106 may be configured (i.e., programmed) to cause the processor 102 to carry out various acts and functions described herein. For example, the described application software component 106 may include and/or correspond to one or more components of an application for managing an app 120, such as an app 120 for a shopfloor computer 130 and field device 142 interplay, wherein the application software component 106 may, for example, be configured to generate and store product data in a data store 108 such as a database.

By way of example, the app development platform 118 may be cloud-based, internet-based and/or be operated by a provider providing support for managing an app 120, such as an app 120 for a shopfloor computer 130 and field device 142 interplay. In some examples, the user of the app development platform 118 managing the app 120 may be located close to the app development platform 118 or remote to the app development platform 118 (e.g., anywhere else; using a mobile device for connecting to the app development platform 118; via the internet, wherein the mobile device may include an input device 110 and a display device 112). In some examples, the app development platform 118 may be installed and run on a user's device, such as a computer, laptop, pad, on-premises computing facility, or the like.

Examples of product systems that may be adapted to include the app management, such as for managing an app 120, such as an app 120 for a shopfloor computer 130 and field device 142 interplay, features described herein, may include the low-code software development platform of Mendix Inc., of Boston, Massachusetts, USA. This platform provides tools to build, test, deploy, iterate, develop, create and manage apps 120 and is based on visual, model-driven software development. However, it should be appreciated that the systems and methods described herein may be used in other product systems (e.g., product lifecycle management (PLM), product data management (PDM), application lifecycle management (ALM) systems) and/or any other type of system that generates and stores product data in a database. Also, examples of databases that may be used as one or more data stores described herein include database server ap-plications such as Oracle, Microsoft SQL Server, or any other type of data store that is operative to store data records.

It should be appreciated that managing an app 120, such as an app 120 for a shopfloor computer 130 and field device 142 interplay, may be a challenging and time-consuming process that may require highly skilled app managers with many years of training and expert domain knowledge. For example, the app manager may need a good understanding of the capabilities of both the shopfloor computer 130 and the respective field device 142 and how to manage information handled by the app 120 and access to such information in this context. Further, knowledge of the production processes executed on the shopfloor 134 and the involved shopfloor computers 130 and the field devices 142 maybe required for a proper management of the app 120. For example, too many or the wrong permissions maybe assigned to shopfloor users using the shopfloor computer 130 that may negatively affect the function or security of the executed app 120. Further, the need of an adequate management of the app 120 may become even more relevant if the app 120 is operated to monitor or to control the respective field device 130, especially if the app 120, an app user interface 156, the shopfloor computer 130 or the field device 142 is safety critical so that the app 120, the app user interface 156, the shopfloor computer 130 or the field device 142 needs to comply with requirements with respect to functional safety.

To enable the enhanced management of an app 120, such as an app 120 for a shopfloor computer 130 and field device 142 interplay, the described product system or processing system 100 may include at least one input device 110 and at least one display device 112 (such as a display screen). The described processor 102 may be configured to generate a graphical user interface (GUI) 114 through the display device 112. Such a GUI 114 may include GUI elements such as buttons, links, search boxes, lists, text boxes, images, scroll bars usable by a user to provide inputs through the input device 110 that cause managing an app 120, such as an app 120 for a shopfloor computer 130 and field device 142 interplay. By way of example, the GUI 114 may include an app management user interface (UI) 116 provided to a user.

In an example embodiment, the application software component 106 and/or the processor 102 may be configured to provide an app management user interface (UI) 116 of an app management platform 118 to a user for managing an app 120 including an app model 122, a plurality of app entities 124, and a plurality of app workflows 126.

As mentioned above, the app management platform 118 may provide or include the above-described functionalities of the management of the app 120, such as an app 120 for a shopfloor computer 130 and field device 142 interplay. In some examples, the app management platform 118 may support visual model-based representations, visual model-based apps, and/or visual models and, by way of example, may be a visual model-based app development platform or a low-code app development platform. The app development UI 116 may provide an interactive user interface of the app management platform 118 that supports and enables the user to manage the app 120, by way of example including developing the app 120. By way of example, the app 120 may be or include a software program that on execution performs specific desired tasks.

The app 120 to be managed may, for example, be used by an end user, such as the shopfloor user, for industrial and/or business purposes. An industrial purpose may, for example, be to use the developed app 120 for analyzing, monitoring, controlling and/or managing an industrial field device 142 or plant including several such fields devices 142, wherein fields devices 142 may be arranged shopfloor 134 of a production facility.

The app 120 may, for example, include an app model 120 that may, in some examples, be understood as a graph. The app model 120 or the graph may, for example, be understood a structure consisting of a set of objects where some pairs of the objects are in some sense “related”. The objects may be represented by abstractions called vertices, also called nodes or points, and each of the related pairs of vertices is called an edge, also called link or line. Typically, a graph may be depicted in diagrammatic form as a set of dots or circles for the vertices, joined by lines or curves for the edges.

By way of example, the app model 122 may be understood in the above-described context of model-based app development and may, for example, correspond to or include the above-mentioned models or visual models used for low-code application development. The app model 122 may, for example, describe the information or data used by the app 120 (e.g., in a visual way; in the form of a graph). In some examples, the graph and the app model 122 may be used interchangeably. Further, the app model 122 may, for example, be a data model that may abstract the structure of a relational database management system (RDBMS) that may store the industrial or business data that may power the app 120. The app model 122 may, for example, include information on input and output variables of the app 120 and how the input and output variables may be interlinked in a meaningful way to fulfill the purpose of the app 120.

The respective model 122 may, for example, be typical for one or more predefined types of apps 120. For example, for the above-mentioned industrial purposes, the respective model 122 may, for example, include control functionalities to control a respective field device 142. Herein, the control functionalities included in the respective app model 122 may, for example, rely on input data, such as sensor data 138, received by the respective field device 142 or another device, such as an edge device 166, that is associated or communicatively coupled with the respective field device 142, wherein the app 120 may, according to the respective app workflow 126 and a corresponding algorithm 172, process the input data to determine the control signals 140 in line with the control functionalities. In another example in the industrial domain, the respective app model 122 may, for example, include monitoring functionalities according to which, based on input data received by the respective field device 142 or the edge device 166, an analysis and a comparison against predefined threshold values may be done to do condition monitoring with respect to the respective field device 142, for example, to determine if the respective device is operated as expected or abnormally (e.g., due to wear, a defect, or a malfunction of the respective field device 142).

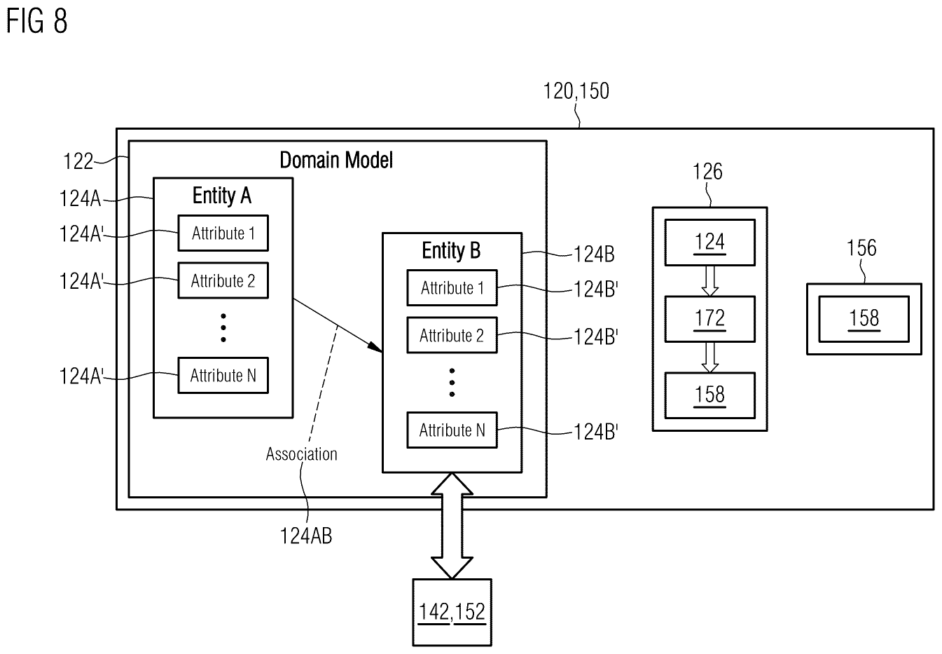

In the present context, the objects or nodes of the app model may include a plurality of app entities 124, where an app entity 124 may, for example, be compared to a table in traditional SQL. App entities 124 may, for example, have app attributes 124′ that may be thought of as fields and may have primitive types like string, int, and date-time. App entities 124 may relate to each other either 1-1, 1-*, or *-* so that the app model 122 or graph may have corresponding edges. The edges of the app model 122 or graph may also be considered to be associations 124AB as sketched in FIG. 8 linking two or more app entities 124.

The app 120 may, for example, further include an app workflow 126 that may, for example, describe how the app entities 124 may relate to each other in terms of data manipulation (e.g., to derive output data from input data using an algorithm 172). By way of example, the app model 122 may, for example, characterize (at least some aspects) the app 120 and/or functionalities of the app 120, wherein in further examples, the app model 122 may include one or more workflows 126 for processing data related to the app entities 124 or app user interfaces (UI) 156 of the app 120, wherein the app UI 156 may serve to display information relating to the app entities 124 or information derived from the app entities 124, to an app user (e.g., via the app UI 156). For example, the app 120 may include the functionality of monitoring or controlling a respective field device 142 based on sensor data 138 associated with the respective field device 142.

The app workflow 126 may, for example, include an algorithm 172 to process the input variables of the app 120 to obtain the output variables of the app 120. Herein, the app workflow 126 may, for example, include one or more tasks that may be executed in the course of the app workflow 126. In the context of the above-mentioned industrial purposes, such an app workflow 126 may include controlling the respective field device 142. In some examples, the mentioned tasks may include providing an app user interface (UI) 156 on the shopfloor computer 130, wherein the app UI 156 may include several UI elements that are arranged in the app UI 156. In further examples, the app workflow 126 may, for example, include retrieving sensor data 138, carrying out an analysis, and a comparison against predefined threshold values for condition monitoring purposes of the respective field device 142 (e.g., to determine if the respective field device 142 is operated as expected or abnormally, such as due to wear, a defect, or a malfunction of the respective field device 142). A notification or an alarm may be provided to the app user (e.g., the shopfloor manager) in case of an abnormal operation of the respective device.

The app 120 or the app model 122, may, for example, be used for analyzing, monitoring, controlling and/or managing an industrial field device or plant including several such fields devices 142.

In an example embodiment, the application software component 106 and/or the processor 102 may further be configured to receive first user input 128 indicative of a shopfloor computer 130 and of a respective field device 142 arranged in a shopfloor 134 of a production facility, respectively, wherein some of the app entities 124 relate to sensor data 138 or to control data 140 associated with one or more field devices 142, and wherein some of the app entities 124 are associated with respective app workflow 126.

For the management of the app 120, the user of the app management platform 118 may provide the first user input 128 in natural language (e.g., in written form using a keyboard as the input device 110 and using an input text box of the app management UI 116). Oral input may also be possible (e.g., using a microphone as the input device 110). By way of example, the app manager may indicate the shopfloor computer 130 and the respective field device 142 to be communicatively connected to the app 120. In some examples, the indicated shopfloor computer 130 and the indicated respective field device 142 may send information to the app 120 or may receive information from the app 120, wherein the indicated shopfloor computer 130 may, for example, process information associated with the app 120. In further examples, the app manager, i.e., the user of the app development platform 118, may make selections from predefined shopfloor computers 130, respective field devices 142 or properties 176 of these devices, wherein the available devices or properties 176 may be displayed to the app manager via the app management UI 116, and wherein a combination of natural language user input and a selection from predefined devices or properties 176 may be possible. Herein the mentioned properties 176 may, for example, include the functionality, computational resources, or connectivity parameters, etc. of the respective shopfloor computer 130 or field device 142. In further examples, the app manager may provide the first user input 128 by chatting with a chatbot that may, for example, be understood to be a software application or web interface that is designed to mimic human conversation through text or voice interactions.

The shopfloor 134 may, for example, be understood as a production area, such as in a factory or another working space and is the floor where workers and/or field devices 142 produce goods. Herein, the corresponding production facility may be associated discrete or process industry.

Some of the app entities 124 may, for example, relate to sensor data 138 that may be detected by the respective field device 142 or an edge device 166 in the vicinity of the respective field device 142 that may then communicate the sensor data 138 to the app 120. Herein, the sensor data 138 may, for example, indicate a value of a physical or chemical observable, such as electric voltage or current, pressure, temperature, acidity, volume flow. In some examples, some of the app entities 124 may relate to control data 140 that may be used to control the respective field device 142. The control data 140 may switch the respective field device 142 on or off or may change the operation of the respective field device 142.

The respective app workflow 126 may, for example, use the sensor data 138 as input data. The sensor data 138 may, for example, be provided as a value of an app entity attribute 124′ of an app entity characterizing the respective field device 142. In some examples, an algorithm 172 of the respective app workflow 126 may, for example, process the sensor data 138 to determine data 158 (e.g., control data 140). The data 158 may, for example, be displayed to a shopfloor manager via the app UI 156. The control data 140 may be communicated to the respective field device 142 to control the respective field device 142.

In the context of the above industrial example, the respective app model 122 and/or app workflow 126 may, for example, include control functionalities to control the respective field device 142. One of the app entities 124 included in the app model 122 may, for example, describe some properties of the respective field device 142, such as an identifier, and a type of respective field device 142 (e.g., a PLC controlling an electric motor). In some examples, another field device 142 may, for example, be assigned to another app entity 124 including an identifier, a type of device (e.g., an electric motor), a rated output power (e.g., 5 kW), and a maximum rotational speed (e.g., 3000 rpm). In some examples, the mentioned properties may correspond to the app attributes 124′ of the respective app entity 124 as sketched in FIG. 8. Further app entities 124 included in the app model 122 may, for example, describe some properties of a complex machine including the respective field device 142, wherein electric motor among the respective field devices 142 may drive the complex machine with a certain actual rotational speed. To control the electric motor, the actual rotational speed of the electric motor may be determined (e.g., by the PLC). In simple examples, a comparison with the maximum rotational speed may be done, and if the actual rotational speed is larger than the maximum rotational speed, the PLC may control the electric motor to reduce the actual rotational speed below the maximum rotational speed. Herein, the comparison and the corresponding control signal may be performed by a corresponding algorithm 172 included in the app workflow 126, wherein the rotational speed may correspond to one of the app entity attributes 124′ of the electric motor field device 142 and wherein the control signal of the PLC may correspond to one of the app entity attributes 124′ of the PLC field device 142.

In an example embodiment, the application software component 106 and/or the processor 102 may further be configured to trigger execution of the app 120 on the app management platform 118.

In some examples, the app 120 may be executed on the app management platform 118 upon receiving the first user input 128 and optionally upon determining the shopfloor computer 130 and the respective field device 142 intended by the user to be associated with the app 120.

By way of example, triggering the execution of the app 120 on the app management platform 118 may include deploying and then running the app 120 on the app management platform 118. Herein, the app 120 may be understood as deployed if the activities that are required to make this app 120 available for use by the user on the app management platform 118 are completed. The app deployment process may include several interrelated activities with possible transitions between them. These activities may occur at the producer side (e.g., by the app developer) or at the consumer side (by the app user or end user) or both. In some examples, the app deployment process may include at least the release of the app 120 and the installation and the activation of the app 120. The release activity may follow from the completed development process and is sometimes classified as part of the development process rather than deployment process. It may include operations required to prepare a system (e.g., the app development platform 118 or an online app store) for assembly and transfer to the computer system(s) (e.g., the app management platform 118) on which it will be run in production. Therefore, it may sometimes involve determining the resources required for the system to operate with tolerable performance and planning and/or documenting subsequent activities of the deployment process. For simple systems, the installation of the app 120 may involve establishing some form of command, shortcut, script or service for executing the software (manually or automatically) of the app 120. For complex systems, it may involve configuration of the system—possibly by asking the end user questions about the intended app use, or directly asking them how they would like it to be configured—and/or making all the required subsystems ready to use. Activation may be the activity of starting up the executable component of software or the app 120 for the first time (which is not to be confused with the common use of the term activation concerning a software license, which is a function of Digital Rights Management systems).

In further examples, triggering the execution of the app 120 may include causing the app management platform 118 to execute or run the app 120 on the app management platform 118.

In an example embodiment, the application software component 106 and/or the processor 102 may further be configured to trigger execution of at least one shopfloor app workflow 144 included in the plurality of app workflows 126 in a web browser 146 executed on the shopfloor computer 130.

The shopfloor computer 130 may, for example, include and execute a web browser 146, i.e., an application for accessing web pages and navigating the Internet. Herein, the shopfloor computer 130 may include a processor 102′ and a display device 112′ (such as a display screen). The processor 102′ may be configured to generate a graphical user interface (GUI) 114′ through the display device 112′. A user interface 116′ of the web browser 146 may be displayed to a user (e.g., the shopfloor manager) via the GUI 114′.

Further, the plurality of app workflows 126 may, for example, include at least one shopfloor app workflow 144 that is configured to be executed in the web browser 146 of the shopfloor computer 130. In some examples, the respective shopfloor app workflow 144 may be executed in the web browser 146 of the shopfloor computer 130 upon receiving the first user input 128 and optionally upon determining the shopfloor computer 130 intended by the user to be associated with the app 120.

In some examples, the relation of the shopfloor app workflow 144 with the other app workflows 126 executed on the app management platform 118 may be understood to correspond to a client-server model that may be a distributed application structure that partitions tasks or workloads between the providers of a resource or service, called servers, and service requesters, called clients. In the present context, the server may correspond to the app management platform 118, and the client may correspond to the shopfloor computer 130. Herein, according to the client-server, a server host may run one or more server programs (here: some of the app workflows 126) that share their resources with clients. A client usually does not share its computing resources, but it may request content or service from a server and may share its own content as part of the request. Hence, the app 120 and the app model 122 may, for example, be understood as a distributed application that may party be executed on the app management platform 118 and partly (namely the shopfloor app workflow 144) on the shopfloor computer 130.

Herein, to trigger the execution of the respective shopfloor app workflow 144, the app management platform 118 may send a corresponding message 132 to the shopfloor computer 130, wherein the shopfloor computer 130—upon receipt of the message 132—may start the execution of the respective shopfloor app workflow 144 in the web browser 146. In further examples, the execution of the respective shopfloor app workflow 144 may be triggered by the shopfloor computer 130 or the user of the shopfloor computer 130 (e.g., the shopfloor manager).

In an example embodiment, the application software component 106 and/or the processor 102 may further be configured to trigger provision of a protocol converter 148 executed on the shopfloor computer 130, wherein the protocol converter 148 is configured to convert a first data format 150 used by the app 120 into a second data format 152 used by the respective field device 142 and vice versa.

By way of example, the first data format 150 may be incompatible with the second data format 152 so that a transmission of information from the app 120 to the respective field device 142 or vice versa may not be possible without the protocol converter 148. Herein, the first data format 150 may correspond to the ASCII format, wherein ASCII is an acronym for American Standard Code for Information Interchange, a character encoding standard for electronic communication. The second data format 152 may, for example, depend on the type of the respective field device 142 and, for example, include Bluetooth, a short-range wireless technology standard that is used for exchanging data between fixed and mobile devices over short distances and building personal area networks. In further examples, the second data format 152 may correspond to the data format used for a serial port, a PC/SC smartcard reader, a TCP/IP connection, or generally other communication protocols.

Herein, the protocol converter 148 may be configured to convert information available in the first data format 150 into information in the second data format 152 and vice versa.

Hence, the transmission of information from or to the respective field device 142 may be enabled using the protocol converter 148. The protocol converter 148 may, for example, be understood as an application that may be provided and executed on the shopfloor computer 130, wherein the protocol converter 148 may be provided and executed upon receiving the first user input 128 and optionally upon determining the shopfloor computer 130 and the respective field device 142 intended by the user to be associated with the app 120. In some examples, the shopfloor computer 130 may include a library including several conversion rules covering a plurality of different data formats 150, 152. The library may, for example, be transmitted from the app management platform 118 to the shopfloor computer 130 (e.g., as part of the message 132). In some examples, the library may be available at a marketplace that is included in the app management platform 118.

By way of example, the safety of the executed app 120 may be provided through an approach allowing a central management of the app 120 by the app manager using the app management platform 118 who may have more experience than a shopfloor manager using the shopfloor computer 130.

In some examples, the application software component 106 and/or the processor 102 may further be configured to trigger provision of a connector 154 executed in the web browser 146, wherein the connector 154 may be configured to communicatively connect the shopfloor app workflow 144 with the protocol converter 148, and wherein the protocol converter 148 may be configured to communicatively connect the connector 154 with the respective field device 142.

By way of example, the connector 154 may be an application that may be executed in the web browser 146 executed on the shopfloor computer 130. The connector may have a first interface towards the shopfloor app workflow 144 or generally to the app 120 and the app model 122 and a second interface towards the protocol converter 148. Hence, the connector 154 may allow for data transfer between the shopfloor app workflow 144 and the protocol converter 148.

In further examples, the app 120 may further include an app user interface (UI) 156 that may also be executed in the web browser 146 executed on the shopfloor computer 130. In such examples, the connector 154 may further be configured to communicatively connect the app UI 156 with the protocol converter 148.

By way of example, the app 120 may further include an app user interface (UI) 156, wherein the application software component 106 and/or the processor 102 may further be configured to trigger display of data 158 associated with one or more of the app entities 124 to a shopfloor user via the app UI 156 displayed via the web browser 146.

By way of example, the app UI 156 may be used to display data 158 associated with one or more of the app entities 124 that may, for example, be determined using the respective app workflow 126. For example, life operation data of the respective field device 142 included in the data 156 may be displayed to shopfloor user via the app UI 156 displayed via the web browser 146.

The display of the data 158 may, for example, be triggered by the app management platform 118 via a corresponding message 132 after a corresponding user input or by the shopfloor computer 130 after a corresponding shopfloor manager user input.

In further examples, the application software component 106 and/or the processor 102 may further be configured to trigger the determination of the data 158 using the sensor data 138 and the respective app workflow 126 including the respective app entity 124 relating to the sensor data 138.

In some examples, the data 158 may be derived from the sensor data 138 using the algorithm 172 that may be included in the app workflow 126. Hence, for example, life operation data of the respective field device 142 or data 156 derived thereof may be displayed to shopfloor user via the app UI 156 displayed via the web browser 146.

The determination of the data 158 may, for example, be triggered by the app management platform 118 via a corresponding message 132 after a corresponding user input or by the shopfloor computer 130 after a corresponding shopfloor manager user input.

By way of example, the application software component 106 and/or the processor 102 may further be configured to display available properties 176 of the respective field device 142 via the app management UI 116 to the user; to receive second user input 174 indicative of properties 176 of the respective field device 142; and to determine at least one of the app entities 124 using second user input 174.

For a facilitated and convenient management of the app 120, available properties 176 of the respective field device 142 may be displayed to the user via the app management UI 116. The app manager may then provide the second user input 174 (e.g., by selecting one or more of the displayed properties 176, or by amending one or more of the displayed properties 176). By way of example, the properties 176 may include an identifier, connectivity details, or a data format of the respective field device 142 or optionally physical or chemical observables relating to the respective field device 142. The respective app entities 124 associated with the respective field device 142 may then be determined using the selected properties 176.

In further examples, some of the app workflows 126 may be executed in a first runtime 160 executed on the app management platform 118, wherein the shopfloor app workflow 144 and if applicable the app UI 156 may be executed in a second runtime 162 executed on the shopfloor computer 130.

By way of example, a runtime may be understood as a sub-system that exists in the computer where a program is created, as well as in the computers where the program is intended to be run. The name comes from the compile time and runtime division from compiled languages, which similarly distinguishes the computer processes involved in the creation of a program (compilation) and its execution in the target machine (the runtime). In the present context, the app management platform 118 may provide the first runtime 160 in which some of the app workflows 126 may be executed. By way of example, the first runtime 160 may be included in the executed app 120. Further, the shopfloor computer 130 may provide the second runtime 163 in which the shopfloor app workflow 144 may be executed. By way of example, the second runtime 162 may be included in the web browser 146.

By way of example, the application software component 106 and/or the processor 102 may further be configured to trigger the communication of the control data 140 from the app 120 and the protocol converter 148 to the respective field device 148, wherein the control data 140 may be configured to trigger the respective field device 142 to execute a field task 164.

The control data 140 may, for example, be received from the user of the app management platform 118 or the control data 140 may be determined using the respective app workflow 120 that is executed on the app management platform 118. The control data 140 may then first be communicated to the shopfloor computer 130 where the control data 140 may be converted from the first data format 150 into the second data format 152 by the protocol converter 148. The control data 140 in the second data format 152 may then be communicated from the shopfloor computer 130 to the respective field device 142 to trigger the respective field device 142 to execute a field task 164. The communication of the control data 140 may, for example, be triggered by the app management platform 118 via a corresponding message 132 after a corresponding user input.

In some examples, the control data 140 may, for example, be received from the user of the shopfloor computer 130 or the control data 140 may be determined using the shopfloor app workflow 144 that is executed on the shopfloor computer 130. The control data 140 may then be converted from the first data format 150 into the second data format 152 by the protocol converter 148. The control data 140 in the second data format 152 may then be communicated from the shopfloor computer 130 to the respective field device 142 to trigger the respective field device 142 to execute a field task 164. The communication of the control data 140 may, for example, be triggered by the shopfloor computer 130 after a corresponding shopfloor manager user input.

In further examples, the application software component 106 and/or the processor 102 may further be configured to receive the sensor data 138 from the respective field device 142; and to determine the control data 140 using the sensor data 138 and the respective app workflow 126 including the respective app entity 124 relating to the sensor data 138.

In some examples, the sensor data 138 may be received from a respective edge device 166 arranged in the shopfloor 134, wherein the respective edge device 166 is communicatively coupled to the shopfloor computer 130 or to an IoT platform 168, wherein the IoT platform 168 may be communicatively coupled with the app management platform 118, and wherein the respective edge device 166 may be configured to communicate the sensor data 138 via the shopfloor computer 130 or via the IoT platform 168 and the app management platform 118 to the protocol converter 148.

Herein, an edge device 166 may, for example, be understood as a device that provides an entry point into enterprise or service provider core networks. Examples of edge devices 166 include routers, routing switches, integrated access devices (IADs), multiplexers, and a variety of metropolitan area network (MAN) and wide area network (WAN) access devices. Edge devices also provide connections into carrier and service provider networks. In an industrial context, an edge device may further be understood as uses edge computing to collect, process, and analyze data, such as the sensor data 138, locally. These edge devices 166 are positioned at the edge of the network, close to where data is generated, removing the need to send the data back to a centralized server or cloud for processing. Edge devices may, for example, be IoT (Internet of Things) devices with built-in edge computing hardware and software, such as smart cameras with real-time video analysis capabilities. Edge devices may also be separate physical devices located near the IoT devices they support, such as edge gateways that aggregate and preprocess data from multiple sensors in a factory.

Further, an IoT platform 168 may be understood as an application or service that provides built-in tools and capabilities to connect every “thing” in an IoT ecosystem (e.g., including the app management platform, the edge devices, and optionally the shopfloor computer 130). An IoT platform 168 may, for example, provide functions including device lifecycle management, device communication, data analytics, integration, and application enablement.

In further examples, the application software component 106 and/or the processor 102 may further be configured to receive third user input 170 indicative of the respective field device 142 to execute the field task 164; and to determine the control data 140 using the third user input 170 and the respective app workflow 126 including the respective app entity 124 relating to the control data 140.

In further examples, the processor 102′ and/or an application software component of the shopfloor computer 130 may be configured to receive a message 132 from an app management platform 118, wherein the app management platform 118 may be configured to execute an app 120 including an app model 122, a plurality of app entities 124, and a plurality of app workflows 126, wherein the message 132 may indicate a respective field device 142 arranged in a shopfloor 134 of a production facility, wherein the message 132 may further include an instruction to execute at least one shopfloor app workflow 144 included in the plurality of app workflows 126 in a web browser 146, wherein the message 132 may further include an instruction to provide a protocol converter 148, wherein the protocol converter 148 may be configured to convert a first data format 150 used by the app 120 into a second data format 152 used by the respective field device 142 and vice versa, wherein some of the app entities 124 may relate to sensor data 138 or to control data 140 associated with one or more field devices 142, and wherein some of the app entities may be associated with respective app workflow. The processor 102′ and/or an application software component of the shopfloor computer 130 may further be configured to execute the respective shopfloor app workflow 144 in the web browser 146; and to provide and executing the protocol converter 148.

In further examples, the processor 102′ and/or an application software component of the shopfloor computer 130 may be configured to receive the sensor data 138 from the respective field device 142; to determine the control data 140 using the sensor data 138 and the respective app workflow 144 including the respective app entity 124 relating to the sensor data 138; and to communicate the control data 140 via the protocol converter 148 to the respective field device 142, wherein the control data 140 may be configured to trigger the respective field device 142 to execute a field task 164.

In some examples, the processor 102′ and/or an application software component of the shopfloor computer 130 may be configured to display data 158 associated with one or more of the app entities 124 to a shopfloor user via an app user interface (UI) 156 included in the app 120 via the web browser 146.

By way of example, the processor 102′ and/or an application software component of the shopfloor computer 130 may be configured to determine the data 158 using the sensor data 138 and the respective app workflow 126 including the respective app entity 124 relating to the sensor data 138.

It should be appreciated that that the described the application software component 106 and/or the processor 102 or 102′ may be configured to carry out an analogous method of managing an app 120, such as an app 120 for a shopfloor computer 130 and field device 142 interplay. Further, the explained examples may be combined to obtain a more detailed method of managing an app 120, such as an app 120 for a shopfloor computer 130 and field device 142 interplay. Further, a computer-readable medium 190 that may include a computer program product 192 is shown in FIG. 1. The computer program product 192 may be encoded with executable instructions that, when executed, cause the product system 100, the app development platform 118, and/or the shopfloor computer 130 to carry out the described method.

Among the advantages of the suggested method is the convenience and ease of the enabled management of the app 120, which may leverage an interplay of a shopfloor computer 130 and a respective field device 142. The suggested approach is accessible to citizen app developers and managers who don't have long training and expert domain knowledge (e.g., of the capabilities of the shopfloor computer 130 and the respective field device 142). Registering the involved devices in the app management platform 118 may be more convenient compared to other approaches, wherein no detailed knowledge of involved data formats is required. The safety of the executed app 120 and, for example, of field tasks 164 may be provided through an approach allowing a central management of the app 120 by the app manager using the app management platform 118 who may have more experience than a shopfloor manager using the shopfloor computer 130.

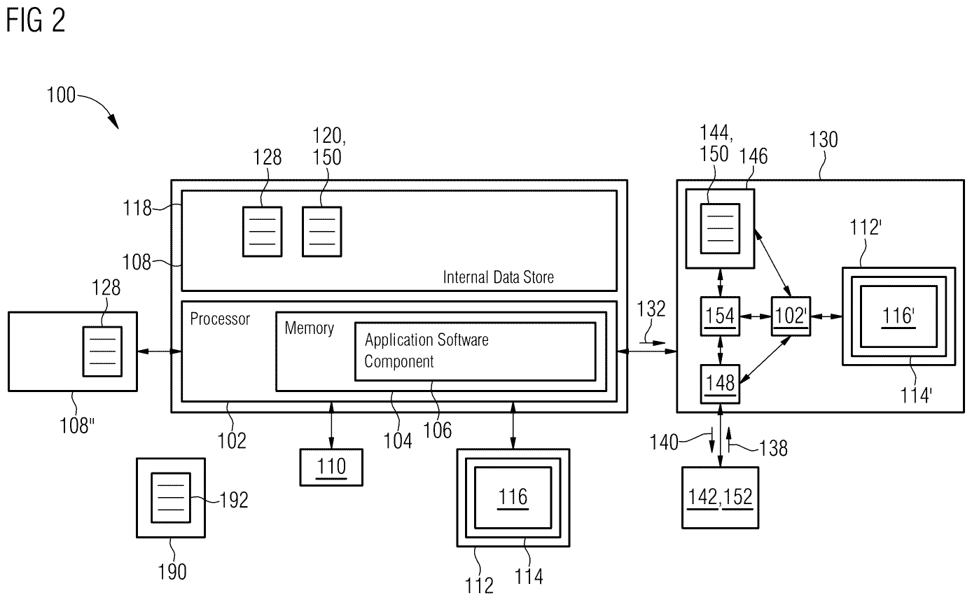

FIG. 2 depicts a functional block diagram of a second example system 100 that facilitates managing an app 120, such as an app 120 for a shopfloor computer 130 and field device 142 interplay, in a product system 100.

The second example system 100 has several similarities with the first example system 100 depicted in FIG. 1. After receiving a corresponding message 132 from the app management platform 118, the shopfloor computer 130 may provide and execute a connector 154 in the web browser 146, wherein the connector 154 may be configured to communicatively connect the shopfloor app workflow 144 with the protocol converter 148, and wherein the protocol converter 148 may be configured to communicatively connect the connector 154 with the respective field device 142.

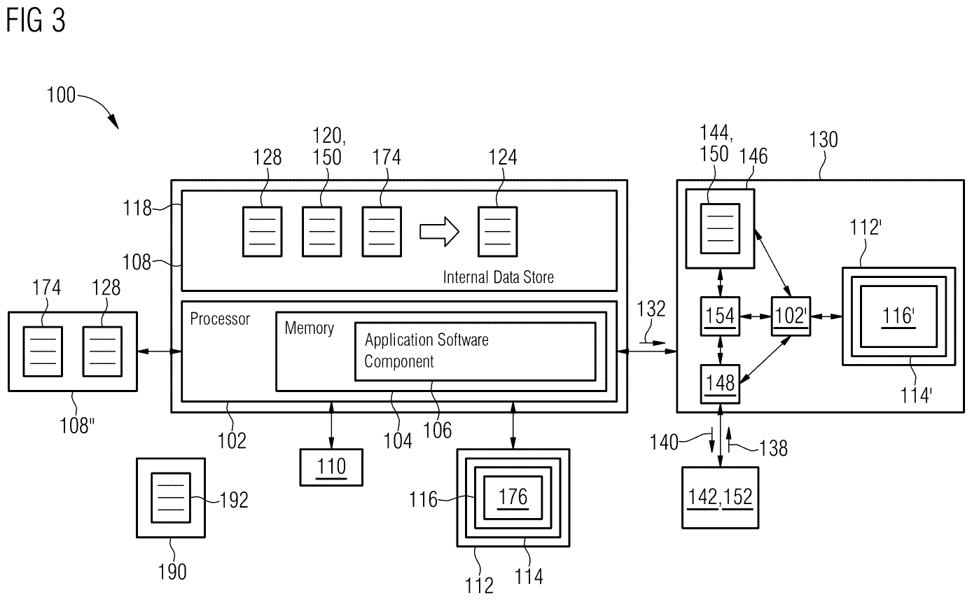

FIG. 3 depicts a functional block diagram of a third example system 100 that facilitates managing an app 120, such as an app 120 for a shopfloor computer 130 and field device 142 interplay, in a product system 100.

The third example system 100 may further be configured to display available properties 176 of the respective field device 142 via the app management UI 116 to the user; to receive second user input 174 indicative of properties 176 of the respective field device 142; and to determine at least one of the app entities 124 using second user input 174.

The third example system 100 has several similarities with the first and second example systems 100 depicted in FIGS. 1 and 2. The third example system 100 may further be configured to determine at least one app characteristic component 134 associated with the respective app characteristic 124 using the second user input 130, wherein the subsidiary prompt 132 indicates the determined respective app characteristic component 134.

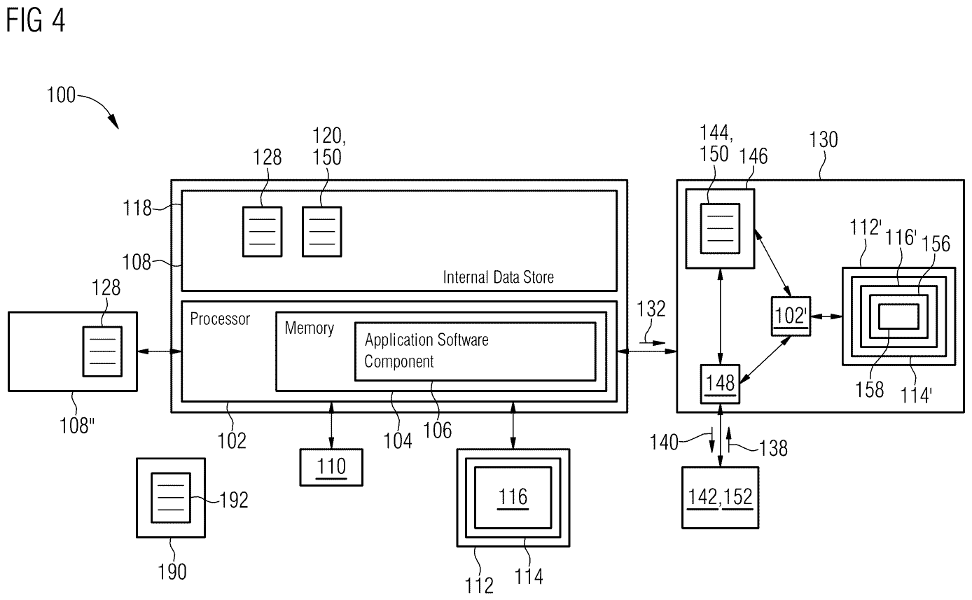

FIG. 4 depicts a functional block diagram of a fourth example system 100 that facilitates managing an app 120, such as an app 120 for a shopfloor computer 130 and field device 142 interplay, in a product system 100.

According to the fourth example system 100, the app 120 may further include an app user interface (UI) 156 in which data 158 associated with one or more of the app entities 124 may be displayed to a shopfloor user via the app UI 156 displayed via the web browser 146. By way of example, the data 158 may be determined using the sensor data 138 and the respective app workflow 126 including the respective app entity 124 relating to the sensor data 138.

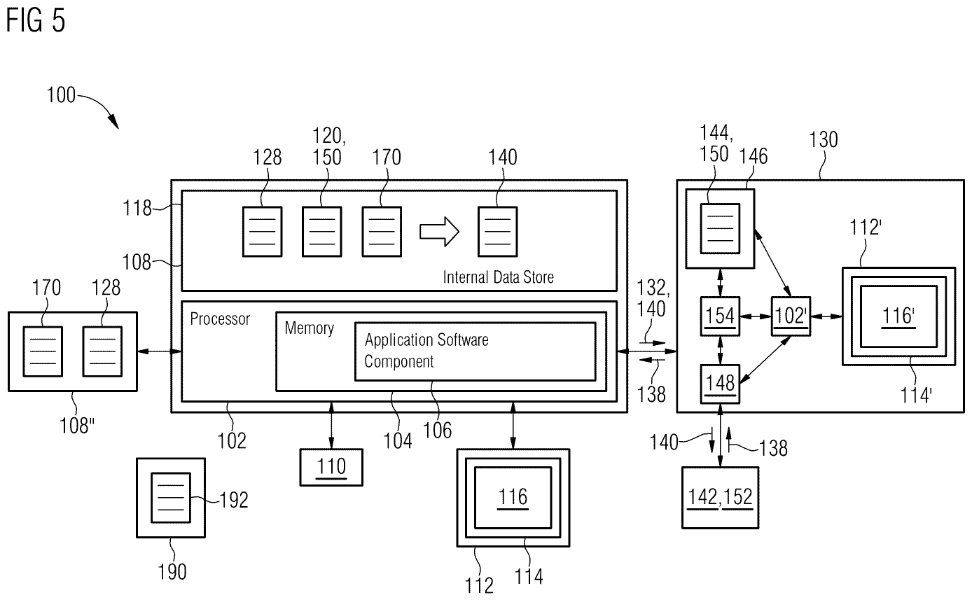

FIG. 5 depicts a functional block diagram of a fifth example system 100 that facilitates managing an app 120, such as an app 120 for a shopfloor computer 130 and field device 142 interplay, in a product system 100.

According to the fifth example system 100, third user input 170 indicative of the respective field device 142 to execute the field task 164 may be received by the app management platform 118. The control data 140 may be determined using the third user input 170 and the respective app workflow 126 including the respective app entity 124 relating to the control data 140.

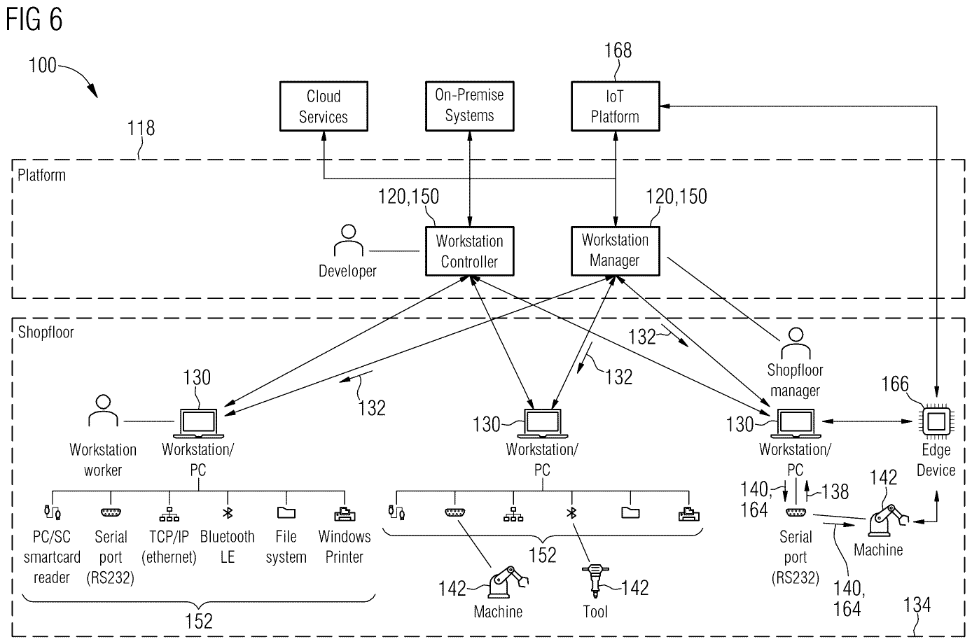

FIG. 6 depicts a functional block diagram of a sixth example system 100 that facilitates managing an app 120, such as an app 120 for a shopfloor computer 130 and field device 142 interplay, in a product system 100.

The sixth example system 100 includes the app management platform 118, which includes the functionality of the “Workstation Controller” 120, 150 to develop the app 120 and of the “Workstation Manager” 120, 150 to manage the app 120 as described herein. The sixth example system 100 further includes the shopfloor 134 including three shopfloor computers 130 (“Workstation/PC”) communicatively coupled with the “Workstation Controller” 120, 150 and the “Workstation Manager” 120, 150 functionalities of the app management platform 118. The respective shopfloor computer 130 is or may be communicatively coupled with one or more field devices 142 thereby using the second data format 152 of the respective field device 142, whereas the respective shopfloor computer 130 communicates with the app 120 or the app management platform 118 using the first data format 150. The shopfloor 134 further includes an edge device 166 that is communicatively coupled with an IoT platform 168 that is communicatively coupled with the “Workstation Controller” 120, 150 and the “Workstation Manager” 120, 150 functionalities of the app management platform 118.

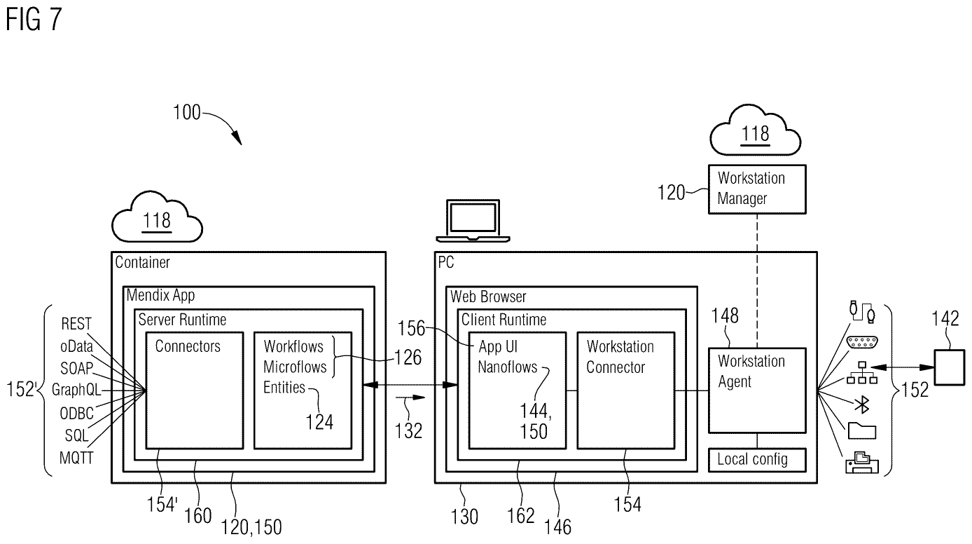

FIG. 7 depicts a functional block diagram of a seventh example system 100 that facilitates managing an app 120, such as an app 120 for a shopfloor computer 130 and field device 142 interplay, in a product system 100.

Herein, the seventh example system 100 corresponds in several aspects to the second example system 100 depicted in FIG. 2 and described above.

According to the seventh example system 100, the first runtime 162 further includes connectors 152′ for communicatively coupling the first runtime 162 and/or the app workflows 126 executed in the first runtime 162 to other data sources using, for example, REST, SQL or MQTT data formats.

FIG. 8 depicts an example schematic overview of an app 120 and an app model 122 in the context of facilitating managing an app 122, such as an app 122 for a shopfloor computer 130 and field device 142 interplay, in a product system 100.

The app 120 may include an app model 122, an app workflow 126, and optionally an app user interface 156 to display the data 158.

The app model 122 may include two or more app entities 124A, 124B that may include app entity attributes 124A′, 124B′, wherein the app entities 124A, 124B may be linked to each other via associations 124AB. Herein, the respective app entity 124B may, for example, characterize one of the field devices 142 that communicates in the second data format 152, whereas the app 120 uses the first data format 150, which is different from the second data format 152.

The app workflow 126 may use one of the app entities 124 as an input that is processed with the algorithm 172 to determine the data 158.

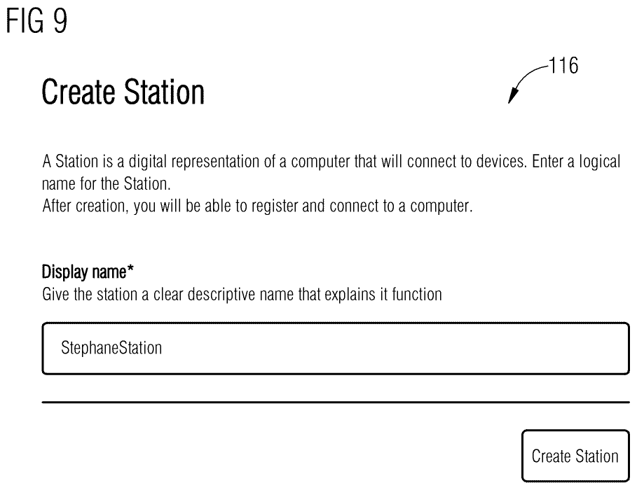

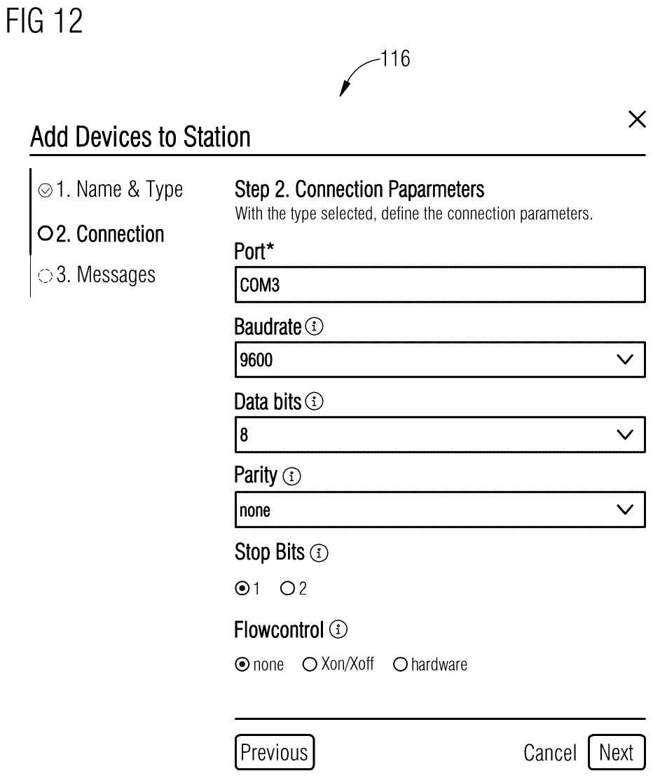

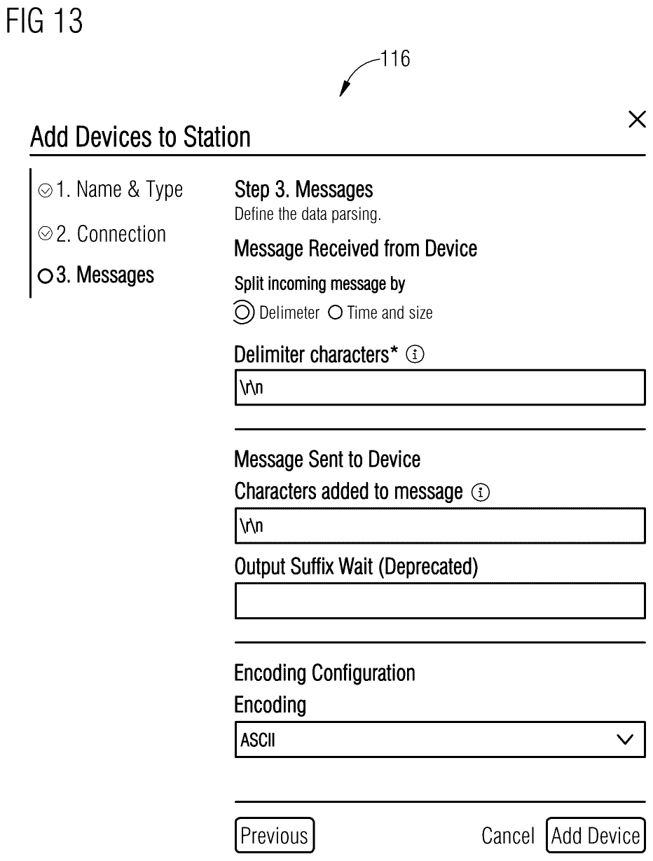

FIGS. 9-14 depict various aspects of example app development user interfaces 116 that facilitate managing an app 116, such as an app 116 for a shopfloor computer 130 and field device 142 interplay, in a product system 100, respectively.

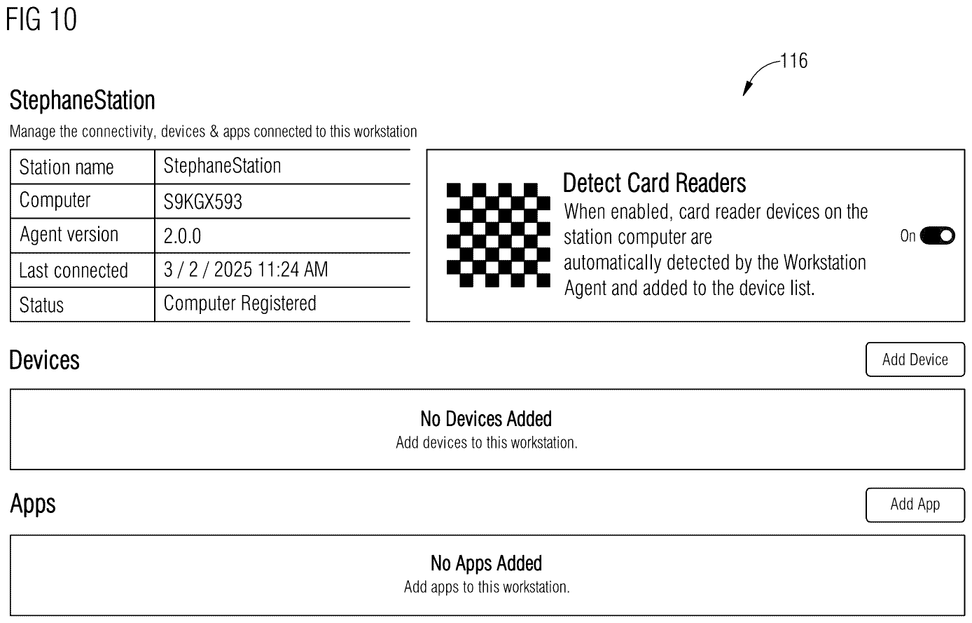

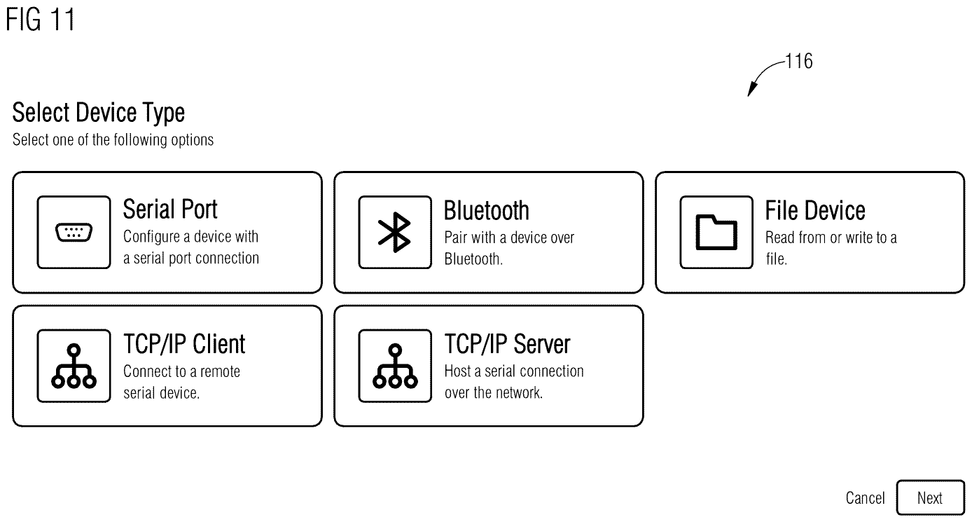

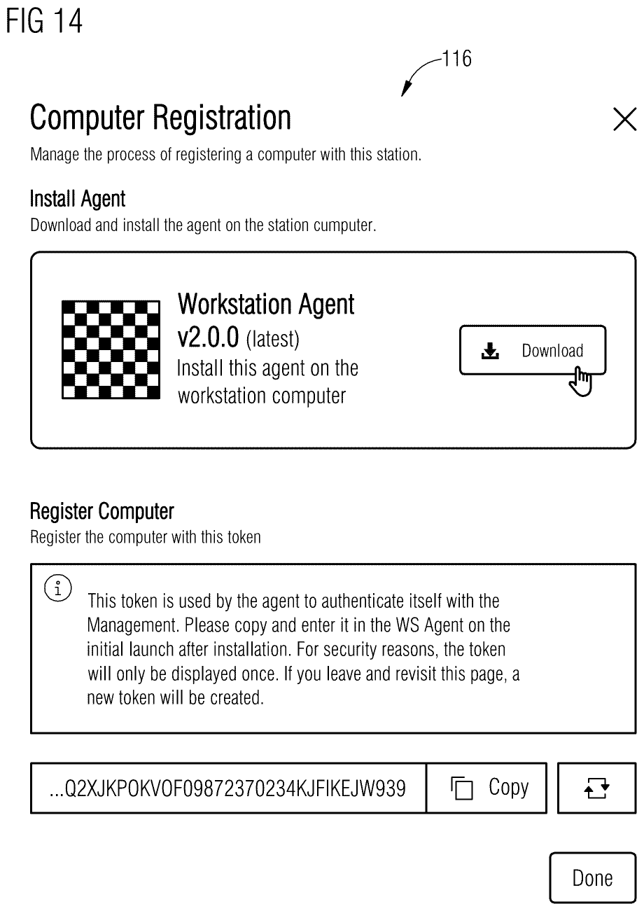

In the app development UI 116 depicted in FIGS. 9 and 10, the user may provide first user input 128 indicative of the shopfloor computer 130. In the app development UI 116 depicted in FIGS. 11 to 13, the user may provide first user input 128 indicative of the field device 142. In the app development UI 116 depicted in FIG. 14, the user may trigger provision of the protocol converter 148 (“Workstation Agent”) executed on the shopfloor computer 130, wherein the protocol converter 148 is configured to convert a first data format 150 used by the app 120 into a second data format 152 used by the respective field device 142 and vice versa.

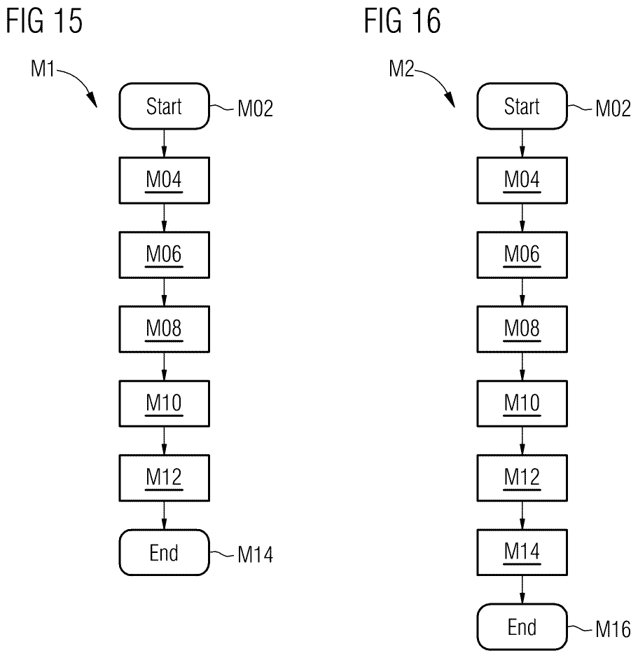

FIG. 15 depicts a flow diagram of a first example methodology M1 that facilitates managing an app, such as an app for a shopfloor computer and field device interplay, in a product system.

The method may start at M02, and the methodology M1 may include several acts carried out through operation of at least one processor. These acts may include an act M04 of providing an app management user interface (UI) of an app management platform to a user for managing an app including an app model, a plurality of app entities, and a plurality of app workflows; an act M06 of receiving first user input indicative of a shopfloor computer and of a respective field device arranged in a shopfloor of a production facility, respectively, wherein some of the app entities relate to sensor data or to control data associated with one or more field devices, and wherein some of the app entities are associated with respective app workflow; an act M08 of triggering execution of the app on the app management platform; an act M10 of triggering execution of at least one shopfloor app workflow included in the plurality of app workflows in a web browser executed on the shopfloor computer; and an act M12 of triggering provision of a protocol converter executed on the shopfloor computer, wherein the protocol converter is configured to convert a first data format used by the app into a second data format used by the respective field device and vice versa. At M14 the methodology may end.

It should further be appreciated that the methodology M1 may include other acts and features discussed previously with respect to the computer-implemented method of managing an app, such as an app for a shopfloor computer and field device interplay, in a product system.

FIG. 16 depicts a flow diagram of a second example methodology M2 that facilitates managing an app, such as an app for a shopfloor computer and field device interplay, in a product system.

The method may start at M02, and the methodology M2 may include several acts carried out through operation of at least one processor. These acts may include an act M04 of providing an app management user interface (UI) of an app management platform to a user for managing an app including an app model, a plurality of app entities, and a plurality of app workflows; an act M06 of receiving first user input indicative of a shopfloor computer and of a respective field device arranged in a shopfloor of a production facility, respectively, wherein some of the app entities relate to sensor data or to control data associated with one or more field devices, and wherein some of the app entities are associated with respective app workflow; an act M08 of triggering execution of the app on the app management platform; an act M10 of triggering execution of at least one shopfloor app workflow included in the plurality of app workflows in a web browser executed on the shopfloor computer; an act M12 of triggering provision of a protocol converter executed on the shopfloor computer, wherein the protocol converter is configured to convert a first data format used by the app into a second data format used by the respective field device and vice versa; and an act M14 of triggering provision of a connector executed in the web browser, wherein the connector is configured to communicatively connect the shopfloor app workflow with the protocol converter, and wherein the protocol converter is configured to communicatively connect the connector with the respective field device. At M16 the methodology may end.

It should further be appreciated that the methodology M2 may include other acts and features discussed previously with respect to the computer-implemented method of managing an app, such as an app for a shopfloor computer and field device interplay, in a product system.

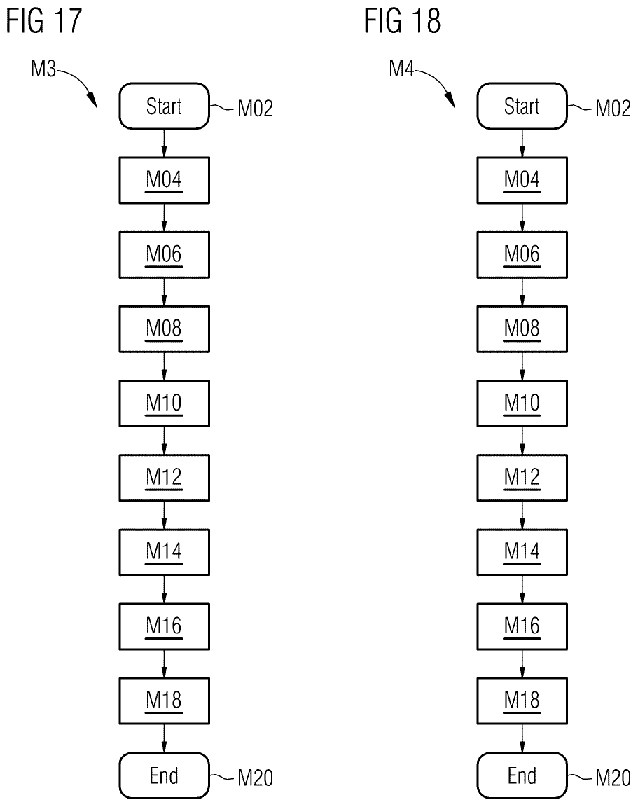

FIG. 17 depicts a flow diagram of a third example methodology M3 that facilitates managing an app, such as an app for a shopfloor computer and field device interplay, in a product system.

The method may start at M02, and the methodology M3 may include several acts carried out through operation of at least one processor. These acts may include an act M04 of providing an app management user interface (UI) of an app management platform to a user for managing an app including an app model, a plurality of app entities, and a plurality of app workflows; an act M06 of receiving first user input indicative of a shopfloor computer and of a respective field device arranged in a shopfloor of a production facility, respectively, wherein some of the app entities relate to sensor data or to control data associated with one or more field devices, and wherein some of the app entities are associated with respective app workflow; an act M08 of triggering execution of the app on the app management platform; an act M10 of triggering execution of at least one shopfloor app workflow included in the plurality of app workflows in a web browser executed on the shopfloor computer; an act M12 of triggering provision of a protocol converter executed on the shopfloor computer, wherein the protocol converter is configured to convert a first data format used by the app into a second data format used by the respective field device and vice versa; an act M14 of displaying available properties of the respective field device via the app management UI to the user; an act M16 of receiving second user input indicative of properties of the respective field device; and an act M18 of determining at least one of the app entities using the second user input. At M20 the methodology may end.

It should further be appreciated that the methodology M3 may include other acts and features discussed previously with respect to the computer-implemented method of managing an app, such as an app for a shopfloor computer and field device interplay, in a product system.

FIG. 18 depicts a flow diagram of a fourth example methodology 43 that facilitates managing an app, such as an app for a shopfloor computer and field device interplay, in a product system.

The method may start at M02, and the methodology M4 may include several acts carried out through operation of at least one processor. These acts may include an act M04 of providing an app management user interface (UI) of an app management platform to a user for managing an app including an app model, a plurality of app entities, and a plurality of app workflows; an act M06 of receiving first user input indicative of a shopfloor computer and of a respective field device arranged in a shopfloor of a production facility, respectively, wherein some of the app entities relate to sensor data or to control data associated with one or more field devices, and wherein some of the app entities are associated with respective app workflow; an act M08 of triggering execution of the app on the app management platform; an act M10 of triggering execution of at least one shopfloor app workflow included in the plurality of app workflows in a web browser executed on the shopfloor computer; an act M12 of triggering provision of a protocol converter executed on the shopfloor computer, wherein the protocol converter is configured to convert a first data format used by the app into a second data format used by the respective field device and vice versa; an act M14 of triggering the communication of the control data from the app and the protocol converter to the respective field device, wherein the control data is configured to trigger the respective field device to execute a field task; an act M16 of receiving the sensor data from the respective field device; and an act M18 of determining the control data using the sensor data and the respective app workflow including the respective app entity relating to the sensor data. At M20 the methodology may end.

It should further be appreciated that the methodology M4 may include other acts and features discussed previously with respect to the computer-implemented method of managing an app, such as an app for a shopfloor computer and field device interplay, in a product system.

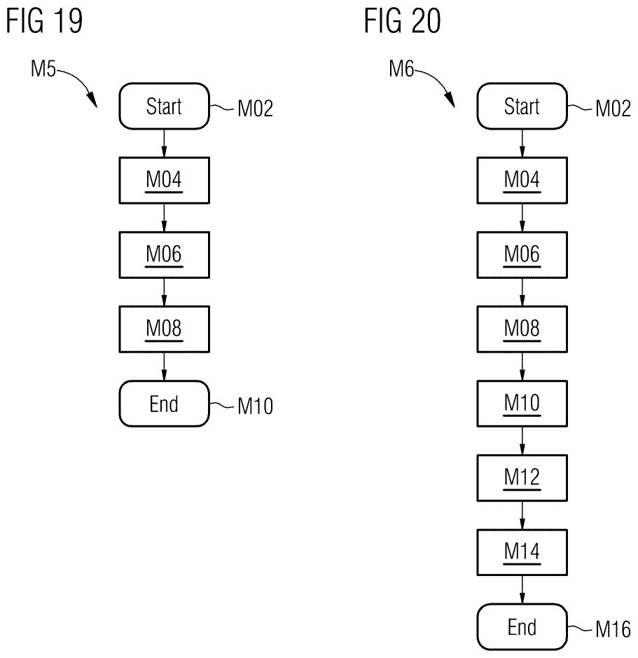

FIG. 19 depicts a flow diagram of a fifth example methodology M5 that facilitates managing an app, such as an app for a shopfloor computer and field device interplay, in a product system.

The method may start at M02, and the methodology M5 may include several acts carried out through operation of at least one processor. These acts may include an act M04 of receiving a message from an app management platform, wherein the app management platform is configured to execute an app including an app model, a plurality of app entities, and a plurality of app workflows, wherein the message indicates a respective field device arranged in a shopfloor of a production facility, wherein the message further includes an instruction to execute at least one shopfloor app workflow included in the plurality of app workflows in a web browser, wherein the message further includes an instruction to provide a protocol converter, wherein the protocol converter is configured to convert a first data format used by the app into a second data format used by the respective field device and vice versa, wherein some of the app entities relate to sensor data or to control data associated with one or more field devices, and wherein some of the app entities are associated with respective app workflow; an act M06 of executing the respective shopfloor app workflow in the web browser; and an act M08 of providing and executing the protocol converter. At M10 the methodology may end.

It should further be appreciated that the methodology M5 may include other acts and features discussed previously with respect to the computer-implemented method of managing an app, such as an app for a shopfloor computer and field device interplay, in a product system.

FIG. 20 depicts a flow diagram of a sixth example methodology M6 that facilitates managing an app, such as an app for a shopfloor computer and field device interplay, in a product system.

The method may start at M02, and the methodology M6 may include several acts carried out through operation of at least one processor. These acts may include an act M04 of receiving a message from an app management platform, wherein the app management platform is configured to execute an app including an app model, a plurality of app entities, and a plurality of app workflows, wherein the message indicates a respective field device arranged in a shopfloor of a production facility, wherein the message further includes an instruction to execute at least one shopfloor app workflow included in the plurality of app workflows in a web browser, wherein the message further includes an instruction to provide a protocol converter, wherein the protocol converter is configured to convert a first data format used by the app into a second data format used by the respective field device and vice versa, wherein some of the app entities relate to sensor data or to control data associated with one or more field devices, and wherein some of the app entities are associated with respective app workflow; an act M06 of executing the respective shopfloor app workflow in the web browser; an act M08 of providing and executing the protocol converter; an act M10 of receiving the sensor data from the respective field device; an act M12 of determining the control data using the sensor data and the respective app workflow including the respective app entity relating to the sensor data; and an act M14 of communicating the control data via the protocol converter to the respective field device, wherein the control data is configured to trigger the respective field device to execute a field task. At M16 the methodology may end.

It should further be appreciated that the methodology M6 may include other acts and features discussed previously with respect to the computer-implemented method of managing an app, such as an app for a shopfloor computer and field device interplay, in a product system.

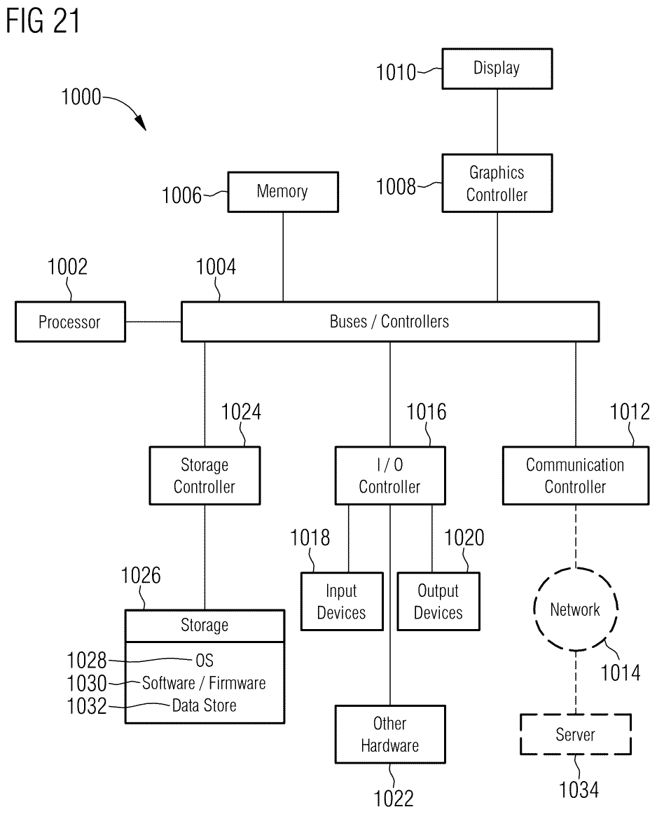

FIG. 21 depicts a block diagram of a data processing system 1000 (also referred to as a computer system) in which an embodiment may be implemented, for example, as a portion of a product system, and/or other system operatively configured by software or otherwise to perform the processes as described herein. The data processing system 1000 may include, for example, the computer or IT system or data processing system 100 mentioned above. The data processing system depicted includes at least one processor 1002 (e.g., a CPU) that may be connected to one or more bridges/controllers/buses 1004 (e.g., a north bridge, a south bridge). One of the buses 1004, for example, may include one or more I/O buses such as a PCI Express bus. Also connected to various buses in the depicted example may include a main memory 1006 (RAM) and a graphics controller 1008. The graphics controller 1008 may be connected to one or more display devices 1010. It should also be noted that in some embodiments one or more controllers (e.g., graphics, south bridge) may be integrated with the CPU (on the same chip or die). Examples of CPU architectures include IA-32, x86-64, and ARM processor architectures.

Other peripherals connected to one or more buses may include communication controllers 1012 (Ethernet controllers, WiFi controllers, cellular controllers) operative to connect to a local area network (LAN), Wide Area Network (WAN), a cellular network, and/or other wired or wireless networks 1014 or communication equipment.

Further components connected to various busses may include one or more I/O controllers 1016 such as USB controllers, Bluetooth controllers, and/or dedicated audio controllers (connected to speakers and/or microphones). It should also be appreciated that various peripherals may be connected to the I/O controller(s) (via various ports and connections) including input devices 1018 (e.g., keyboard, mouse, pointer, touch screen, touch pad, drawing tablet, trackball, buttons, keypad, game controller, gamepad, camera, microphone, scanners, motion sensing devices that capture motion gestures), output devices 1020 (e.g., printers, speakers) or any other type of device that is operative to provide inputs to or receive outputs from the data processing system. Also, it should be appreciated that many devices referred to as input devices or output devices may both provide inputs and receive outputs of communications with the data processing system. For example, the processor 1002 may be integrated into a housing (such as a tablet) that includes a touch screen that serves as both an input and display device. Further, it should be appreciated that some input devices (such as a laptop) may include a plurality of different types of input devices (e.g., touch screen, touch pad, keyboard). Also, it should be appreciated that other peripheral hardware 1022 connected to the I/O controllers 1016 may include any type of device, machine, or component that is configured to communicate with a data processing system.

Additional components connected to various busses may include one or more storage controllers 1024 (e.g., SATA). A storage controller may be connected to a storage device 1026 such as one or more storage drives and/or any associated removable media, which may be any suitable non-transitory machine usable or machine-readable storage medium. Examples include nonvolatile devices, volatile devices, read only devices, writable devices, ROMs, EPROMs, magnetic tape storage, floppy disk drives, hard disk drives, solid-state drives (SSDs), flash memory, optical disk drives (CDs, DVDs, Blu-ray), and other known optical, electrical, or magnetic storage devices drives and/or computer media. Also, in some examples, a storage device such as an SSD may be connected directly to an I/O bus 1004 such as a PCI Express bus.

A data processing system in accordance with an embodiment of the present disclosure may include an operating system 1028, software/firmware 1030, and data stores 1032 (that may be stored on a storage device 1026 and/or the memory 1006). Such an operating system may employ a command line interface (CLI) shell and/or a graphical user interface (GUI) shell. The GUI shell permits multiple display windows to be presented in the graphical user interface simultaneously, with each display window providing an interface to a different application or to a different instance of the same application. A cursor or pointer in the graphical user interface may be manipulated by a user through a pointing device such as a mouse or touch screen. The position of the cursor/pointer may be changed and/or an event, such as clicking a mouse button or touching a touch screen, may be generated to actuate a desired response. Examples of operating systems that may be used in a data processing system may include Microsoft Windows, Linux, UNIX, iOS, and Android operating systems. Also, examples of data stores include data files, data tables, relational database (e.g., Oracle, Microsoft SQL Server), database servers, or any other structure and/or device that is capable of storing data that is retrievable by a processor.

The communication controllers 1012 may be connected to the network 1014 (not a part of data processing system 1000), which may be any public or private data processing system network or combination of networks, as known to those of skill in the art, including the Internet. Data processing system 1000 may communicate over the network 1014 with one or more other data processing systems such as a server 1034 (also not part of the data processing system 1000). However, an alternative data processing system may correspond to a plurality of data processing systems implemented as part of a distributed system in which processors associated with several data processing systems may be in communication by way of one or more network connections and may collectively perform tasks described as being performed by a single data processing system. Thus, it is to be understood that when referring to a data processing system, such a system may be implemented across several data processing systems organized in a distributed system in communication with each other via a network.

Further, the term “controller” may be any device, system, or part thereof that controls at least one operation, whether such a device is implemented in hardware, firmware, software, or some combination of at least two of the same. It should be noted that the functionality associated with any particular controller may be centralized or distributed, whether locally or remotely.

In addition, it should be appreciated that data processing systems may be implemented as virtual machines in a virtual machine architecture or cloud environment. For example, the processor 1002 and associated components may correspond to a virtual machine executing in a virtual machine environment of one or more servers. Examples of virtual machine architectures include VMware ESCi, Microsoft Hyper-V, Xen, and KVM.

Those of ordinary skill in the art will appreciate that the hardware depicted for the data processing system may vary for particular implementations. For example, the data processing system 1000 in this example may correspond to a computer, workstation, server, PC, notebook computer, tablet, mobile phone, and/or any other type of apparatus/system that is operative to process data and carry out functionality and features described herein associated with the operation of a data processing system, computer, processor, and/or a controller discussed herein. The depicted example is provided for the purpose of explanation only and is not meant to imply architectural limitations with respect to the present disclosure.

Also, it should be noted that the processor described herein may be located in a server that is remote from the display and input devices described herein. In such an example, the described display device and input device may be comprised in a client device that communicates with the server (and/or a virtual machine executing on the server) through a wired or wireless network (which may include the Internet). In some embodiments, such a client device, for example, may execute a remote desktop application or may correspond to a portal device that carries out a remote desktop protocol with the server in order to send inputs from an input device to the server and receive visual information from the server to display through a display device. Examples of such remote desktop protocols include Teradici's PCoIP, Microsoft's RDP, and the RFB protocol. In such examples, the processor described herein may correspond to a virtual processor of a virtual machine executing in a physical processor of the server.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

Also, as used herein a processor corresponds to any electronic device that is configured via hardware circuits, software, and/or firmware to process data. For example, processors described herein may correspond to one or more (or a combination) of a microprocessor, CPU, FPGA, ASIC, or any other integrated circuit (IC) or other type of circuit that is capable of processing data in a data processing system, which may have the form of a controller board, computer, server, mobile phone, and/or any other type of electronic device.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 1000 may conform to any of the various current implementations and practices known in the art.

Also, it should be understood that the words or phrases used herein should be construed broadly, unless expressly limited in some examples. For example, the terms “comprise” and “include,” as well as derivatives thereof, provide inclusion without limitation. The singular forms “a”, “an” and “the” are intended to comprise the plural forms as well, unless the context clearly indicates otherwise. Further, the term “and/or” as used herein refers to and encompasses any and all possible combinations of one or more of the associated listed items. The term “or” is inclusive, providing and/or unless the context clearly indicates otherwise. The phrases “associated with” and “associated therewith,” as well as derivatives thereof, may be to comprise, be comprised within, interconnect with, contain, be contained within, connect to or with, couple to or with, be communicable with, cooperate with, interleave, juxtapose, be proximate to, be bound to or with, have, have a property of, or the like.

Also, although the terms “first”, “second”, “third” and so forth may be used herein to describe various elements, functions, or acts, these elements, functions, or acts should not be limited by these terms. Rather these numeral adjectives are used to distinguish different elements, functions or acts from each other. For example, a first element, function, or act could be termed a second element, function, or act, and, similarly, a second element, function, or act could be termed a first element, function, or act, without departing from the scope of the present disclosure.

In addition, phrases such as “processor is configured to” carry out one or more functions or processes may provide that the processor is operatively configured to or operably configured to carry out the functions or processes via software, firmware, and/or wired circuits. For example, a processor that is configured to carry out a function/process may correspond to a processor that is executing the software/firmware, which is programmed to cause the processor to carry out the function/process and/or may correspond to a processor that has the software/firmware in a memory or storage device that is available to be executed by the processor to carry out the function/process. It should also be noted that a processor that is “configured to” carry out one or more functions or processes, may also correspond to a processor circuit particularly fabricated or “wired” to carry out the functions or processes (e.g., an ASIC or FPGA design). Further the phrase “at least one” before an element (e.g., a processor) that is configured to carry out more than one function may correspond to one or more elements (e.g., processors) that each carry out the functions and may also correspond to two or more of the elements (e.g., processors) that respectively carry out different ones of the one or more different functions.

In addition, the term “adjacent to” may provide that an element is relatively near to but not in contact with a further element; or that the element is in contact with the further portion, unless the context clearly indicates otherwise.

Although example embodiments of the present disclosure have been described in detail, those skilled in the art will understand that various changes, substitutions, variations, and improvements disclosed herein may be made without departing from the spirit and scope of the disclosure in its broadest form.

None of the description in the present patent document should be read as implying that any particular element, step, act, or function is an essential element that must be included in the claim scope. The scope of patented subject matter is defined only by the allowed claims.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

### REFERENCE SIGNS LIST

100 processing system
102 processor
104 memory
106 application software component
108 internal data store
110 input device
112 display device
114 graphical user interface (GUI)
116 app management UI
118 app management platform
120 app
122 app model
124 app entity
126 app workflow
128 first user input
130 shopfloor computer
132 message
134 shopfloor
138 sensor data
140 control data
142 field device
144 shopfloor app workflow
146 web browser
148 protocol converter
150 first data format
152 second data format
154 connector
156 app user interface
158 data
160 first runtime
162 second runtime
164 field task
166 edge device
168 IoT platform
170 third user input
172 algorithm
174 second user input
190 computer-readable medium
192 computer program product

1. A computer-implemented method comprising:
providing an app management user interface (UI) of an app management platform to a user for managing an app including an app model, a plurality of app entities, and a plurality of app workflows;
receiving a first user input indicative of a shopfloor computer and of a respective field device arranged in a shopfloor of a production facility, respectively, wherein some app entities of the plurality of app entities relate to sensor data or to control data associated with one or more field devices, and wherein some app entities of the plurality of app entities are associated with a respective app workflow of the plurality of app workflows;
triggering execution of the app on the app management platform;
triggering execution of at least one shopfloor app workflow included in the plurality of app workflows in a web browser executed on the shopfloor computer; and
triggering provision of a protocol converter executed on the shopfloor computer,
wherein the protocol converter is configured to convert a first data format used by the app into a second data format used by the respective field device and vice versa.

2. The computer-implemented method of claim 1, further comprising:
triggering provision of a connector executed in the web browser,
wherein the connector is configured to communicatively connect the shopfloor app workflow with the protocol converter, and
wherein the protocol converter is configured to communicatively connect the connector with the respective field device.

3. The computer-implemented method of claim 1, wherein the app further includes an app user interface (UI), and
wherein the method further comprises:
triggering display of data associated with one or more app entities of the plurality of app entities to a shopfloor user via the app UI displayed via the web browser.

4. The computer-implemented method of claim 3, further comprising:
triggering determination of the data using the sensor data and the respective app workflow including the respective app entity relating to the sensor data.

5. The computer-implemented method of claim 1, further comprising:
displaying available properties of the respective field device via the app management UI to the user;
receiving second user input indicative of properties of the respective field device; and
determining at least one of the app entities using the second user input.

6. The computer-implemented method of claim 1, wherein some app workflows of the plurality of app workflows are executed in a first runtime executed on the app management platform, and
wherein the shopfloor app workflow is executed in a second runtime executed on the shopfloor computer.

7. The computer-implemented method of claim 3, wherein some app workflows of the plurality of app workflows are executed in a first runtime executed on the app management platform, and
wherein the app UI is executed in a second runtime executed on the shopfloor computer.

8. The computer-implemented method of claim 1, further comprising:
triggering the communication of the control data from the app and the protocol converter to the respective field device,
wherein the control data is configured to trigger the respective field device to execute a field task.

9. The computer-implemented method of claim 8, further comprising:
receiving the sensor data from the respective field device; and
determining the control data using the sensor data and the respective app workflow including the respective app entity relating to the sensor data.

10. The computer-implemented method of claim 9, wherein the sensor data is received from a respective edge device arranged in the shopfloor,
wherein the respective edge device is communicatively coupled to the shopfloor computer or to an IoT platform,
wherein IoT platform is communicatively coupled with the app management platform, and
wherein the respective edge device is configured to communicate the sensor data via the shopfloor computer or via the IoT platform and the app management platform to the protocol converter.

11. The computer-implemented method of claim 8, further comprising:
receiving third user input indicative of the respective field device to execute the field task; and
determining the control data using the third user input and the respective app workflow including the respective app entity relating to the control data.

12. A computer-implemented method comprising:
receiving a message from an app management platform, wherein the app management platform is configured to execute an app including an app model, a plurality of app entities, and a plurality of app workflows, wherein the message indicates a respective field device arranged in a shopfloor of a production facility, wherein the message further includes an instruction to execute at least one shopfloor app workflow included in the plurality of app workflows in a web browser, wherein the message further includes an instruction to provide a protocol converter, wherein the protocol converter is configured to convert a first data format used by the app into a second data format used by the respective field device and vice versa, wherein some app entities of the plurality of app entities relate to sensor data or to control data associated with one or more field devices, and wherein some of the app entities are associated with respective app workflow;
executing the respective shopfloor app workflow in the web browser; and
providing and executing the protocol converter.

13. The computer-implemented method of claim 12, further comprising:
receiving the sensor data from the respective field device;
determining the control data using the sensor data and the respective app workflow including the respective app entity relating to the sensor data; and
communicating the control data via the protocol converter to the respective field device,
wherein the control data is configured to trigger the respective field device to execute a field task.

14. The computer-implemented method of claim 12, further comprising:
displaying data associated with one or more of the app entities to a shopfloor user via an app user interface (UI) included in the app via the web browser.

15. The computer-implemented method of claim 14, further comprising:
determining the data using the sensor data and the respective app workflow including the respective app entity relating to the sensor data.

16. A computer system comprising:
a processor configured to:
provide an app management user interface (UI) of an app management platform to a user for managing an app including an app model, a plurality of app entities, and a plurality of app workflows;
receive a first user input indicative of a shopfloor computer and of a respective field device arranged in a shopfloor of a production facility, respectively, wherein some app entities of the plurality of app entities relate to sensor data or to control data associated with one or more field devices, and wherein some app entities of the plurality of app entities are associated with a respective app workflow of the plurality of app workflows;
trigger execution of the app on the app management platform;
trigger execution of at least one shopfloor app workflow included in the plurality of app workflows in a web browser executed on the shopfloor computer; and
trigger provision of a protocol converter executed on the shopfloor computer,
wherein the protocol converter is configured to convert a first data format used by the app into a second data format used by the respective field device and vice versa.

17. In a non-transitory computer-readable storge medium that stores instructions executable by one or more processors, the instructions comprising:
providing an app management user interface (UI) of an app management platform to a user for managing an app including an app model, a plurality of app entities, and a plurality of app workflows;
receiving a first user input indicative of a shopfloor computer and of a respective field device arranged in a shopfloor of a production facility, respectively, wherein some app entities of the plurality of app entities relate to sensor data or to control data associated with one or more field devices, and wherein some app entities of the plurality of app entities are associated with a respective app workflow of the plurality of app workflows;
triggering execution of the app on the app management platform;
triggering execution of at least one shopfloor app workflow included in the plurality of app workflows in a web browser executed on the shopfloor computer; and
triggering provision of a protocol converter executed on the shopfloor computer,
wherein the protocol converter is configured to convert a first data format used by the app into a second data format used by the respective field device and vice versa.
